(19) United States
(12) Patent Application Publication
(10) Pub. No.: US 2016/0186483 A1
(43) Pub. Date: Jun. 30, 2016

(54) DRAFT STOPPING SEAL

(71) Applicant: Kathleen Ann Kroeger, Dobbs Ferry, NY (US)

(72) Inventor: Kathleen Ann Kroeger, Dobbs Ferry, NY (US)

(21) Appl. No.: 14/757,852

(22) Filed: Dec. 24, 2015

Related U.S. Application Data
(60) Provisional application No. 62/097,454, filed on Dec. 29, 2014.
(60) Provisional application No. 62/103,487, filed on Jan. 14, 2015.

(51) Int. Cl. E06B 7/23

(52) U.S. Cl. CPC E06B 7/23; E06B 7/2314

(57) ABSTRACT

A draft stopping seal for a door frame and hinge-mounted door, where an elongated foam tube of sufficient length is equal to the frame width and/or frame height. A fabric sheath envelopes said tube and may have a predetermined decorative aspect. An elongated tongue extends outwardly from said sheath and a means are provided to said tongue to secure said seal to the door frame.

This application claims the benefit of U.S. Provisional Application Ser. No. 62/097,454 filed Dec. 29, 2014 and U.S. Provisional Application Ser. No. 62/103,487 filed Jan. 14, 2015.

### BACKGROUND OF THE INVENTION

The present invention relates to an apparatus in the nature of flexible draft stoppers for sealing the tops and vertical sides of doors to supplement the conventional horizontal draft-stopping sealing of door bottoms. Bottoms of doors are often provided with temporary seals against drafts by deploying horizontal weighted tubular sheaths (“snakes”) which are in the nature of fabric tubes or “snakes” filled with sand, rice, beans, or like pliable materials, along the floor surfaces adjacent the bottoms of the doors. Alternatively, “brush seals” or U-shaped extruded forms may be fastened directly to the door bottoms to stop drafts. Many of the horizontal floor door stoppers have decorative designs or patterns included on the surfaces of the sheaths.

The prior art also shows the use of conventional weather stripping. Conventional weather generally consists of thin strips of foam adhered to the door jamb. When the door is closed, the weather stripping is compressed thereby providing a seal between the door and the jamb. This does not provide adequate draft prevention to compromised doors or uneven closures since conventional weather stripping does not support flexible various sizes of gaps and is not large enough to fill such gaps without compromising the door's function.

### SUMMARY OF THE PRESENT INVENTION

The new draft stopper of the present invention is an elongated extruded deformable material, advantageously foam of circular cross-section, of a length approximately equal to the width and/or height of the door to be draft-proofed, which foam is enveloped with a fabric or fabric-like sheath, preferably decorated, having a mounting tongue along substantially its entire length. In the preferred embodiment, the draft stopper is used on a standard door and remains in place for an extended period of time during which the door is opened and closed numerous times during the day. In other embodiments, the draft stopper of this invention is intended to be used one time or only a few times and then discarded. The mounting tongue includes means by which the new draft stopper may be secured along the door edge immediately adjacent the door frame. The securing means is preferably pressure-sensitive adhesive tape When the door is closed in the door frame, the new draft stopper not only bridges any gaps or openings between the door frame and the edge of the door, but it provides decoration of the door interior by virtue of the exposed fabric and its designs. When the door is engaged in the closed position, the new draft stopper compresses slightly to fill any gaps, even of compromised or severely warped doors, making it a “one-size-fits-all” draft stopper.

In another embodiment, the draft stopper of this invention can be made of disposable geotextile fabric for use at a construction site, for example where a portion of a home is being renovated and it is important to seal the construction area from the rest of the home in order to prevent dust and dirt infiltration. In that instance, the draft seal of this invention is applied and left in place during the construction phase and then discarded when construction is complete.

Yet another embodiment is use around fire doors. In this embodiment, the draft seal is applied along all four edges of the door to prevent fire and smoke from moving from one room to another, and it would be fabricated from fire retardant materials.

For a better appreciation of the present invention and its attendant advantages, reference should be made to the following detailed description taken in conjunction with the accompanying drawings.

### DESCRIPTION OF THE DRAWINGS

FIG. 1 is a front prospective view of a length of the new draft stopping seal of the present invention;

FIG. 2 is an end elevation view of the seal of FIG. 1.

FIG. 3 is a perspective view of the new seal with part of the sheath removed showing the foam core;

FIG. 4 is an elevational view showing the draft stopping seal mounted on a door;

FIG. 5 is a partial view showing the bendability of the draft stopping seal towards the 90° corner bend B shown in FIG. 4.

FIG. 6 is a partial perspective view showing the removal of the protective strip to expose the self-adhesive layer on the tongue;

FIG. 7 is a partial front perspective view of the draft-stopping seal applied to the top door edge and vertical door edge with a portion of the tongue excised adjacent the door hardware.

FIG. 8 is a partial side elevational perspective showing excised tongue portion adjacent the door hardware; and

FIG. 9 is a partial near perspective view of the seal applied to the top and side door edges forming the 90° corner bend B shown in FIG. 4.

### DETAILED DESCRIPTION OF THE INVENTION

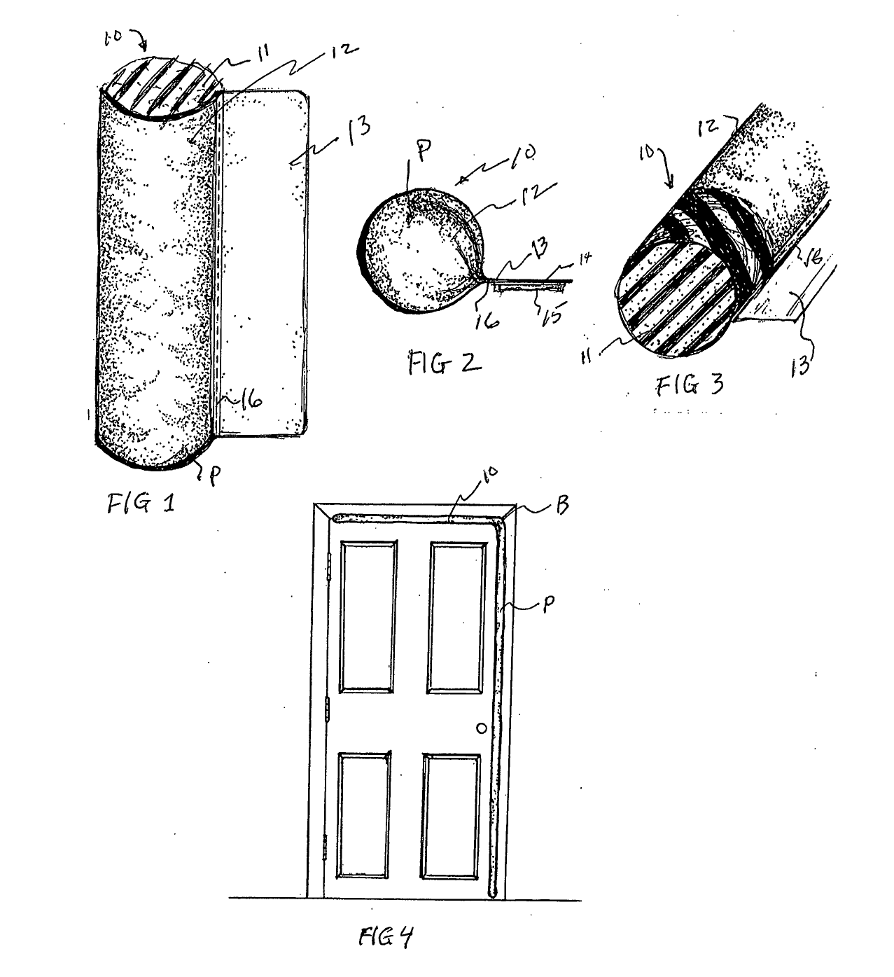

Referring initially to FIGS. 1, 2, 3 and 6, the draft stopping seal 10 includes an elongated tubular deformable member, preferably foam core 11, advantageously of circular cross section, enveloped by a fabric or fabric-like sheath 12, having an integral projecting tongue 13. The tongue 13 mounts securing means, preferably a self-adhesive layer 14 with an overlying removable protective release strip 15. The deformable core 11 may be fabricated from flexible, open cell thermoplastic foam, such as polyethylene or polyurethane, and have a diameter of approximately one inch to one and a quarter inch for typical doors. Alternatively, neoprene rubber foam may be employed. The core may also be made of other deformable materials such as shredded cotton batting. The length will be sufficient to extend along the edge or edges of the door to be draft-proofed. If it is to seal corner edges, an additional approximate inch in length is provided for each corner bend B. If the draft-stopping seal of this invention is to be used to draft-proof the side and top of a “standard” 36 inch door (36″×80″) the length will be approximately 117 inches. Additional lengths may be included as break away pieces or other extentions for longer doors above standard sizes.

While self-adhesive tape is preferred, other well-known attachment means may be employed, for example hook and loop fasteners (Velcro®), glue, nails, magnetic strips (especially useful for steel doors) and the like, all of which are within the scope of the instant invention.

The sheath 12 is preferably formed from a woven durable fabric or the like such as packcloth nylon, cotton or polyester fabrics which may be of bright colors and include predetermined decorative patterns “P.” The sheath 12 is formed from cloth sheet which both envelops the foam core along i substantially its entire length and ends and includes the integral tongue 13. The sheath is established by a line of stitching 16 extending for substantially the entire length of the seal. The stitching 16 closes the sheath and delineates the integral tongue 13 as well as enclosing the opposite ends of the core 11. The sheath can also be formed of fire retardant or fire-proof material primarily for use around fire doors, In addition, when used on fire doors, the seal may incorporate ambient absorbed photo luminescent materials.

The preferred self-stick pressure-sensitive adhesive layer 14 is applied to the tongue by utilizing a 3-M double-stick adhesive tape to permanently adhere the latent adhesive layer 14 to the tongue along with the release strip 15. Alternatively, a hook or loop side of a hook and loop fastener may be attached along the length of the tongue. The mating side of the hook and loop fastener would then be attached to the door edge.

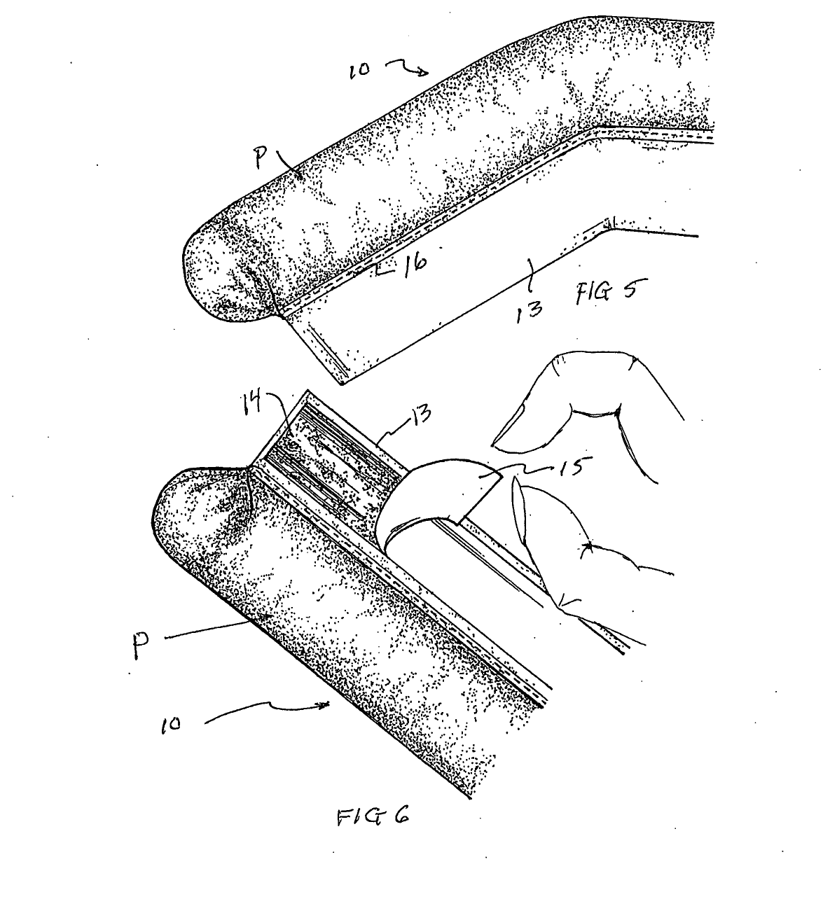

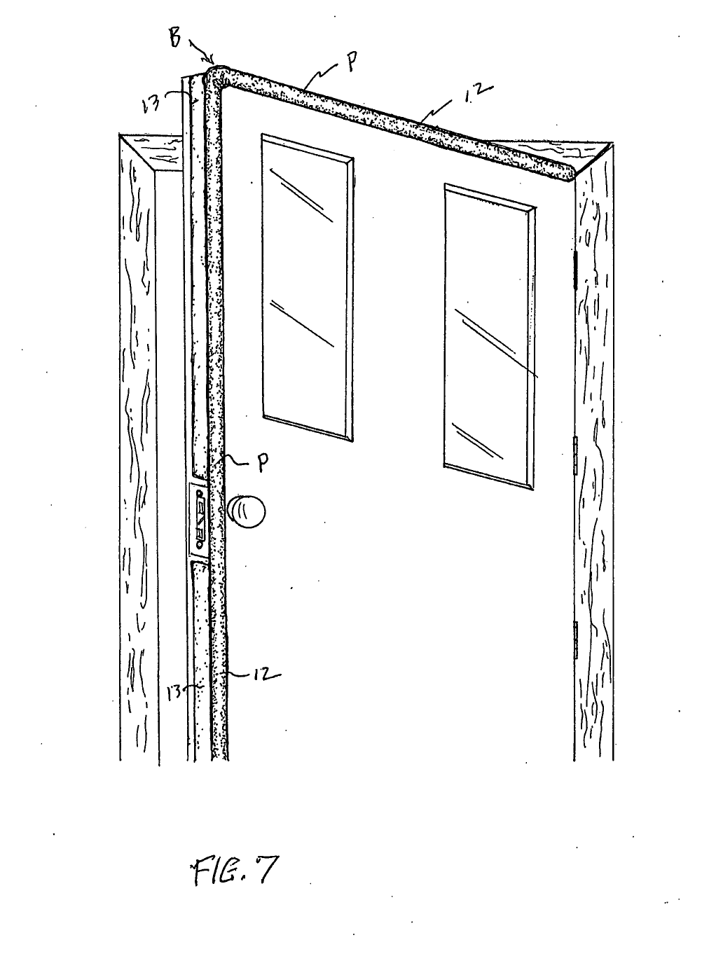

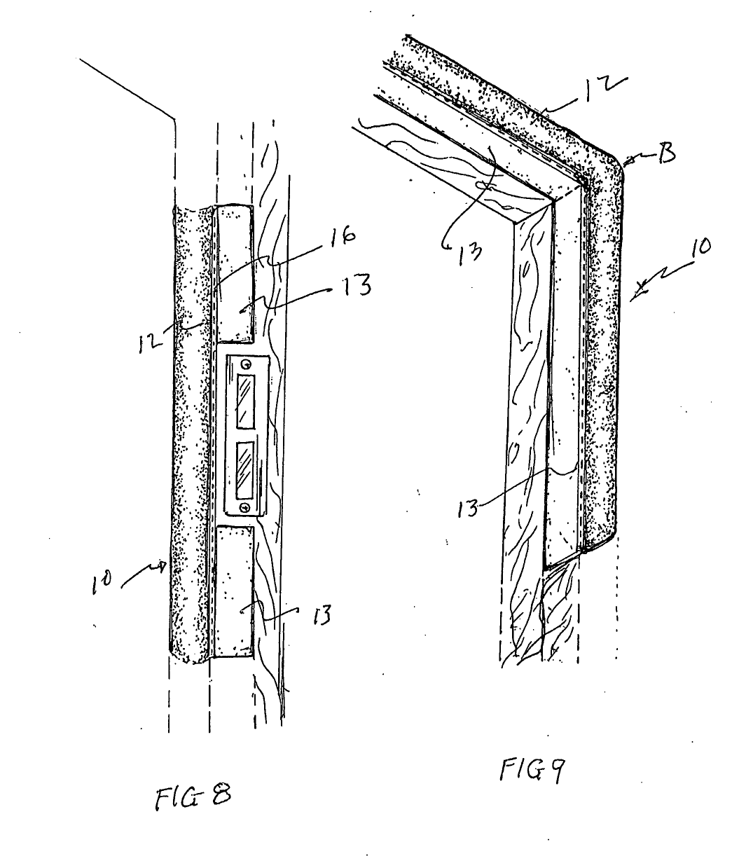

To install the preferred embodiment of the new draft stopping seal 10 on a door (see FIGS. 7, 8, and 9), the protective strip 15 is removed as shown in FIG. 6, and the elongate seal 10 is adhered by adhesive strip 14 along the entire horizontal top edge of the door (FIG. 9) with the sheath at the intersection of door edge and door face and along the entire vertical edge of the door with the sheath at the vertical side edge of the door and with the sheath easily bending into a 90° turn B at the upper corner of the door. The seal 10 is self-biasing against the frame when the door is closed to bridge and to seal any gaps, thereby eliminating drafts which otherwise occur. Of course, if the draft is present only the top edge, the draft stopping seal need only be attached only along the top in a shorter version of the new draft stopper. Similarly, if the draft is present only at the side, the seal need be attached only along the side of the draft with appropriate lengths.

In addition, a sheath constructed from fabric with predetermined decorative indicia, such as holiday themes or other decorative themes, may be included.

Where there is door-latching hardware along the vertical edge of the door as shown in FIG. 8, the portion of the tongue 13 which otherwise would cover the hardware is simply excised by a U-shaped cut which does not intersect the stitching 16. Alternatively, both the tongue and the foam can be excised at that location or the draft stopper may be fabricated with tongue excised already. Advantageously and where desirable, the removable tongue portion may be established by perforations in the tongue so that it may be readily removed during installation.

It will be appreciated that the installed new draft stopping seal (FIG. 1) not only supplements known weather stripping but may entirely eliminate the need for the same. In addition, it may provide an additional aesthetic aspect to ordinary doors.

It should be understood, of course, that the specific form of the invention herein illustrated and described is intended to be representative only, as certain changes may be made therein without departing from the clear teachings of the disclosure such as the cross-sectional shape of the core 11. Accordingly, reference should be made to the following appended claims in determining the full scope of the invention.

I claim:

1. A draft stopping seal for a door frame and hinge-mounted door having four edges, namely a top edge, two side edges and a bottom edge, comprising:
(a) an elongated deformable tube of sufficient length equal to at least one edge of said frame;
(b) a fabric sheath enveloping said tube;
(c) an elongated tongue extending outwardly from said sheath;
(d) securing means along substantially its entire length;
(e) means whereby said securing means functions to attach said tongue to said door edge.

2. The seal of claim 1 in which:
(a) said tube is of circular cross-section.

3. The seal of claim 1 in which:
(a) said tube is polyurethane foam.

4. The seal of claim 1 in which:
(a) said tube is polyethylene foam

5. The seal of claim 1 in which:
(a) said tube is neoprene foam.

6. The seal of claim 1 in which:
(a) said tube is woven textile fabric.

7. The seal of claim 1 in which:
(a) said tube is geotextile fabric.

8. The seal of claim 1 in which:
(a) said tube is fire-proof.

9. The seal of claim 1 in which:
(a) said securing means is comprised of self-stick adhesive tape.

10. The seal of claim 1 in which:
(a) said sheath includes a decoration.
